(19) United States
(12) Patent Application Publication
(10) Pub. No.: US 2024/0344376 A1
(43) Pub. Date: Oct. 17, 2024

(54) WIRING DOOR HINGE

(71) Applicant: Shandong Huajing Glass Co., Ltd, Qingzhou (CN)

(72) Inventors: Jianqing Qi, Qingzhou (CN); Xintian Li, Qingzhou (CN); Yongqing Zhang, Qingzhou (CN)

(21) Appl. No.: 18/740,712

(22) Filed: Jun. 12, 2024

(30) Foreign Application Priority Data
Apr. 12, 2023 (CN) 202320857749.2

(51) Int. Cl. E05D 11/00; H01R 13/70

(52) U.S. Cl. CPC E05D 11/0081; H01R 13/701

(57) ABSTRACT

The present disclosure discloses a wiring door hinge, comprising a wiring door hinge. An end of the wiring door hinge is penetrated by a fixing bolt. A female terminal is mounted at a lower end of the wiring door hinge. A surface of the wiring door hinge is provided with a connection slot. A door body cast steel part is mounted inside the wiring door hinge in a fitting manner. An end of the door body cast steel part is connected with a spring piece. A lower end of the door body cast steel part is connected with a wiring terminal. The other end of the door body cast steel part is connected with a connecting pipe.

### CROSS-REFERENCE TO RELATED APPLICATION

The present disclosure claims the priority to the Chinese patent application with the filling No. 2023208577492 filed with the Chinese Patent Office on Apr. 12, 2023, and entitled “WIRING DOOR HINGE”, the contents of which are incorporated herein by reference in entirety.

### TECHNICAL FIELD

The present disclosure relates to the technical field of cooling cabinets, and particularly to a wiring door hinge.

### BACKGROUND ART

Cooling cabinets are used for the rapid cooling of processed food during food production, thus facilitating subsequent packaging and storage. Compared to traditional cooling methods, they are characterized by fast cooling speed, uniform cooling temperature, preventing secondary contamination of food by the environment, improving the quality of cooked food products, low energy consumption, and convenient transportation. The wiring door hinge is used to mount the door leaf of the cooling cabinet and connect the door frame, thus allowing the door leaf to open freely.

However, existing wiring door hinges have some drawbacks. The existing wiring door hinges facilitate automatic power on or off, which can lead to increased power consumption of the cooling cabinet. Therefore, a wiring door hinge is provided to address the aforementioned issues.

### SUMMARY

The objective of the present disclosure is to provide a wiring door hinge, which can utilize the rebound force from the spring piece to achieve power conduction. When the wiring door hinge is disassembled from the door frame of a cooling cabinet, the spring piece, under its own rebound force, is out of contact with the door body cast steel part, thus automatically disconnecting the power supply. When the wiring door hinge is mounted on the door frame of the cooling cabinet, the door frame of the cooling cabinet presses the spring piece, and the spring piece contacts the door body cast steel part, thus automatically connecting the power supply.

In order to realize the above objective, the present disclosure provides the following technical solutions. A wiring door hinge is provided, comprising a wiring door hinge, wherein an end of the wiring door hinge is penetrated by a fixing bolt. A female terminal is mounted at a lower end of the wiring door hinge. A surface of the wiring door hinge is provided with a connection slot. A door body cast steel part is mounted inside the wiring door hinge in a fitting manner. An end of the door body cast steel part is connected with a spring piece. A lower end of the door body cast steel part is connected with a wiring terminal. Another end of the door body cast steel part is connected with a connecting pipe.

Preferably, three groups of the fixing bolts are arranged on a surface of the wiring door hinge, and the three groups of fixing bolts are distributed and arranged in a triangular pattern.

Preferably, an inner wall of the wiring door hinge is distributed and arranged in a concave form, and an outer wall of the door body cast steel part is distributed and arranged in a convex form.

Preferably, a dimension of the concave form of the inner wall of the wiring door hinge matches a dimension of the convex form of the outer wall of the door body cast steel part, and the wiring door hinge and the door body cast steel part are of a snap-fit structure.

Preferably, the connection slots are arranged along a central axis of the wiring door hinge in a symmetrical manner. The spring pieces are arranged along a central axis of the door body cast steel part in a symmetrical manner. An internal shape of the connection slot is larger than an external shape of the spring piece.

Preferably, the female terminals and wiring terminals are respectively arranged in three groups at one end of the wiring door hinge and the door body cast steel part, and the three groups of female terminals and wiring terminals are fixedly connected.

Preferably, a surface of the connecting pipe is made of an insulating material.

Compared with the prior art, the beneficial effects of the present disclosure are described below.
1. Through the arrangement of the wiring door hinge, the spring piece, and the door body cast steel part, the wiring door hinge can realize the power conduction by using the rebound force from the spring piece. When the wiring door hinge is disassembled from the door frame of a cooling cabinet, the spring piece, under its own rebound force, is out of contact with the door body cast steel part, thus automatically disconnecting the power supply. When the wiring door hinge is mounted on the door frame of the cooling cabinet, the door frame of the cooling cabinet presses the spring piece, and the spring piece contacts the door body cast steel part, thus automatically connecting the power supply.

### BRIEF DESCRIPTION OF DRAWINGS

FIG. 1 is a front view of the present disclosure;

FIG. 2 is a schematic diagram of a structure of a wiring door hinge of the present disclosure;

FIG. 3 is a schematic diagram of a structure of the door body cast steel part of the present disclosure;

FIG. 4 is a side view of the door body cast steel part of the present disclosure; and

FIG. 5 is a top view of a female terminal of the present disclosure.

In the figure: 1—wiring door hinge; 2—fixing bolt; 3—female terminal; 4—connection slot; 5—door body cast steel part; 6—spring piece; 7—wiring terminal; 8—connecting pipe.

### DETAILED DESCRIPTION OF EMBODIMENTS

The technical solutions in the embodiments of the present disclosure will be clearly and completely described below in conjunction with the drawings in the embodiments of the present disclosure. Obviously, the described embodiments are only a part of the embodiments of the present disclosure, and not all of the embodiments. Based on the embodiments in the present disclosure, all other embodiments obtained by those of ordinary skill in the art without making inventive efforts are within the scope of protection of the present disclosure.

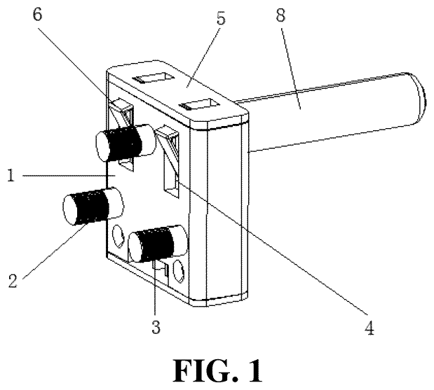

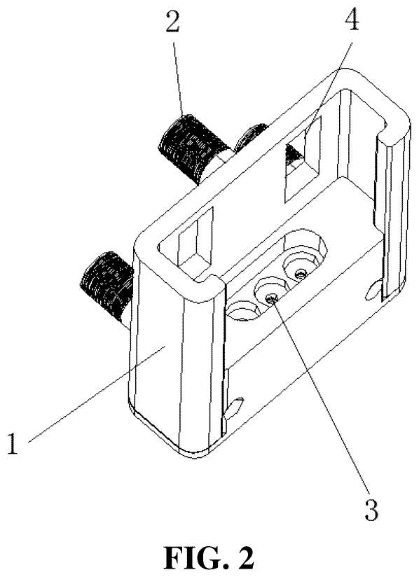

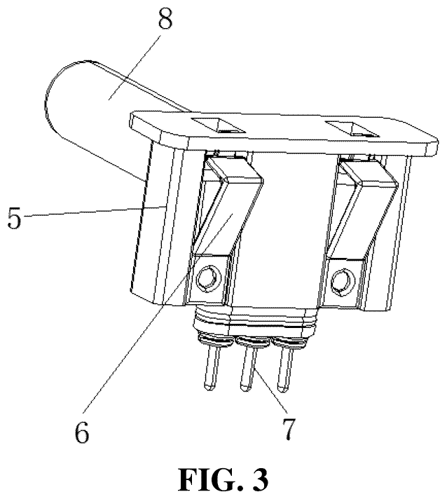

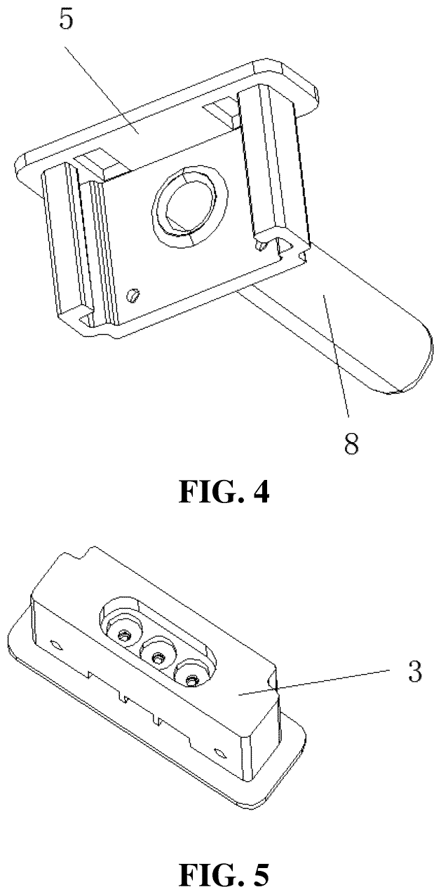

Referring to FIGS. 1-5, the present disclosure provides a technical solution. A wiring door hinge is provided, including a wiring door hinge 1, wherein an end of the wiring door hinge 1 is penetrated by a fixing bolt 2. Three groups of fixing bolts 2 are arranged on a surface of the wiring door hinge 1, and the three groups of fixing bolts 2 are distributed and arranged in a triangular pattern. With the use of three groups of fixing bolts 2, the wiring door hinge 1 can be mounted to the door frame of the cooling cabinet. A female terminal 3 is mounted at a lower end of the wiring door hinge 1. A surface of the wiring door hinge 1 is provided with a connection slot 4.

A door body cast steel part 5 is mounted inside the wiring door hinge 1 in a fitting manner; An inner wall of the wiring door hinge 1 is distributed and arranged in a concave form, and an outer wall of the door body cast steel part 5 is distributed and arranged in a convex form, A dimension of the concave form of the inner wall of the wiring door hinge 1 matches a dimension of the convex form of the outer wall of the door body cast steel part 5, and the wiring door hinge 1 and the door body cast steel part 5 are of a snap-fit structure. With the snap-fit structure between the wiring door hinge 1 and the door body cast steel part 5, the wiring door hinge 1 and the door body cast steel part 5 can be mounted fixedly, thus facilitating subsequent connection to the spring piece 6.

An end of the door body cast steel part 5 is connected with a spring piece 6. The connection slots 4 are arranged along a central axis of the wiring door hinge 1 in a symmetrical manner. The spring pieces 6 are arranged along a central axis of the door body cast steel part 5 in a symmetrical manner. An internal shape of the connection slot 4 is larger than an external shape of the spring piece 6. A rebound force from the spring piece 6 can be utilized to achieve power conduction. When the wiring door hinge 1 is disassembled from the door frame of a cooling cabinet, the spring piece 6, under its own rebound force, is out of contact with the door body cast steel part 5, thus automatically disconnecting the power supply. When the wiring door hinge 1 is mounted on the door frame of the cooling cabinet, the door frame of the cooling cabinet presses the spring piece 6, and the spring piece 6 contacts the door body cast steel part 5, thus automatically connecting the power supply. A lower end of the door body cast steel part 5 is connected with a wiring terminal 7. The female terminals 3 and wiring terminals 7 are respectively arranged in three groups at one end of the wiring door hinge 1 and the door body cast steel part 5, and the three groups of female terminals 3 and wiring terminals 7 are fixedly connected. Another end of the door body cast steel part 5 is connected with a connecting pipe 8. A surface of connecting pipe 8 is made of an insulating material, thus protecting the user and avoiding electrical leakage.

The working principle is as follows. For this type of wiring door hinge, with the snap-fit structure between the wiring door hinge 1 and the door body cast steel part 5, the wiring door hinge 1 and the door body cast steel part 5 can be mounted fixedly, thus facilitating subsequent connection to the spring piece 6. Then, with the use of three groups of fixing bolts 2, the wiring door hinge 1 can be mounted to the door frame of the cooling cabinet. Subsequently, a rebound force from the spring piece 6 can be utilized to achieve power conduction. When the wiring door hinge 1 is disassembled from the door frame of a cooling cabinet, the spring piece 6, under its own rebound force, is out of contact with the door body cast steel part 5, thus automatically disconnecting the power supply. Finally, when the wiring door hinge 1 is mounted on the door frame of the cooling cabinet, the door frame of the cooling cabinet presses the spring piece 6, and the spring piece 6 contacts the door body cast steel part 5, thus automatically connecting the power supply. In this way, the entire process of using the wiring door hinge is completed.

Although embodiments of the present disclosure have been illustrated and described, it is understood that those ordinarily skilled in the art can make various changes, modifications, substitutions, and variations to these embodiments without departing from the principles and spirit of the present disclosure. The scope of the present disclosure is defined by the appended claims and their equivalents.

What is claimed is:

1. A wiring door hinge, comprising a wiring door hinge, wherein an end of the wiring door hinge is penetrated by a fixing bolt; a female terminal is mounted at a lower end of the wiring door hinge; a surface of the wiring door hinge is provided with a connection slot; a door body cast steel part is mounted inside the wiring door hinge in a fitting manner; an end of the door body cast steel part is connected with a spring piece; a lower end of the door body cast steel part is connected with a wiring terminal; and another end of the door body cast steel part is connected with a connecting pipe.

2. The wiring door hinge according to claim 1, wherein three groups of fixing bolts are arranged on a surface of the wiring door hinge, and the three groups of fixing bolts are distributed and arranged in a triangular pattern.

3. The wiring door hinge according to claim 1, wherein an inner wall of the wiring door hinge is distributed and arranged in a concave form, and an outer wall of the door body cast steel part is distributed and arranged in a convex form.

4. The wiring door hinge according to claim 1, wherein a dimension of the concave form of the inner wall of the wiring door hinge matches a dimension of the convex form of the outer wall of the door body cast steel part, and the wiring door hinge and the door body cast steel part are of a snap-fit structure.

5. The wiring door hinge according to claim 1, wherein connection slots are arranged along a central axis of the wiring door hinge in a symmetrical manner, and spring pieces are arranged along a central axis of the door body cast steel part in a symmetrical manner; and an internal shape of the connection slot is larger than an external shape of the spring piece.

6. The wiring door hinge according to claim 1, wherein female terminals and wiring terminals are respectively arranged in three groups at one end of the wiring door hinge and the door body cast steel part, and the three groups of female terminals and wiring terminals are fixedly connected.

7. The wiring door hinge according to claim 1, wherein a surface of the connecting pipe is made of an insulating material.

8. The wiring door hinge according to claim 3, wherein a dimension of the concave form of the inner wall of the wiring door hinge matches a dimension of the convex form of the outer wall of the door body cast steel part, and the wiring door hinge and the door body cast steel part are of a snap-fit structure.
